(19) United States
(12) Patent Application Publication
(10) Pub. No.: US 2026/0088315 A1
(43) Pub. Date: Mar. 26, 2026

(54) Arrangement and Fuel Cell Device

(71) Applicant: Arno Bayer, Dettingen (DE)

(72) Inventor: Arno Bayer, Dettingen (DE)

(73) Assignee: EKPO FUEL CELL TECHNOLOGIES GMBH, Dettingen (DE)

(21) Appl. No.: 19/406,351

(22) Filed: Dec. 2, 2025

Related U.S. Application Data
(63) Continuation of application No. PCT/EP2024/065230, filed on Jun. 3, 2024.

(30) Foreign Application Priority Data
Jun. 6, 2023 (DE) 10 2023 114 835.4

(51) Int. Cl. H01M 8/0297; B23K 26/244

(52) U.S. Cl. CPC H01M 8/0297; B23K 26/244

(57) ABSTRACT

The aim of the invention is to improve an arrangement which comprises several flat components in particular for a fuel-cell device, wherein at least two flat components are welded together by means of at least one weld seam that extends along a weld contour. According to the invention, in at least one weld seam, at least two partial weld seam portions at least partially overlap in a region of overlap along the weld contour.

### CROSS-REFERENCE TO RELATED PATENT APPLICATIONS

This patent application is a Continuation of International Patent Application No. PCT/EP2024/065230, filed Jun. 3, 2024. This patent application claims the benefit of German Patent Application No. 10 2023 114 835.4, filed Jun. 6, 2023, the entire teachings and disclosure each of which are incorporated herein by reference thereto.

### DESCRIPTION

The invention relates to an arrangement comprising several flat components, which is designed in particular for a fuel-cell device, and to a fuel-cell device and methods for producing said fuel-cell device.

The object of the invention is to improve an arrangement comprising several flat components and a fuel-cell device, as well as to improve methods for producing said fuel-cell device.

In embodiments of the invention, the underlying object is achieved by an arrangement comprising several flat components, in particular for a fuel-cell device, wherein at least two flat components are welded together by at least one weld seam running along a weld contour, and wherein, in at least one weld seam, at least two portions of the weld seam are formed to at least partially overlap in a region of overlap along the weld contour.

In embodiments of the invention, the underlying object is achieved by a fuel-cell device comprising several flat components, e.g., an arrangement of several flat components, wherein at least two flat components are welded together by at least one weld seam running along a weld contour, and wherein, in at least one weld seam, at least two portions of the weld seam are formed to at least partially overlap in a region of overlap along the weld contour.

In particular, an advantage of the solution according to the invention is that the weld contour is formed continuously due to the at least partially overlapping design of the portions in the region of overlap and, because at least two portions along the weld contour are formed to be at least partially overlapping, a space-saving solution is provided.

In particular, the overlap runs along the weld contour such that a longitudinal overlap is formed.

In particular, the directions of the at least two at least partially overlapping portions run at most slightly obliquely and preferably at least substantially parallel to one another.

Advantageously, the directions of travel, which are at most slightly oblique to one another, form an angle of at most 50°, in particular of at most 40°, advantageously of at most 30°—for example, of at most 20°.

In particular, in embodiments of the invention, the weld seam has a fluid-tight effect at least in the region of overlap, i.e., in particular a liquid-tight and/or gas-tight effect, and a fluid seal is achieved particularly advantageously by the formation which overlaps at least partially along the weld contour.

For example, the at least partially overlapping formation along the weld seam achieves a positive connection between the at least two overlapping portions.

In some embodiments, it is particularly advantageous that seam irregularities can be compensated for by the at least partially overlapping formation of the at least two portions in the region of overlap.

In particular, at least some of the flat components in the fuel-cell device at least co-form a conduit system for at least one medium.

In particular, at least some of the flat components at least co-form at least one electrical device in the fuel-cell device.

In particular, the solution according to the invention has a particularly advantageous effect upon the fuel-cell device as a whole, because a connection between the at least two flat components is improved by the weld seam with at least two overlapping portions, and thus in particular a functionality of the fuel-cell device and, for example, its efficiency is increased and/or rejects in production are reduced, and thus the fuel-cell device can be manufactured more cost-effectively.

In particular, at least one weld seam with at least two at least partially overlapping portions seals the piping system at least partially and thus advantageously at least reduces the risk of leakage.

Advantageously, at least one weld seam with at least two at least partially overlapping portions can be formed more uniformly according to the solution according to the invention, and, for example, an electrical connection between the at least two welded flat components is thereby improved and, for example, produced more reliably, whereby the functionality of the fuel-cell device can be advantageously improved, and, for example, its efficiency and/or reliability can be increased.

For example, at least one weld seam has only one region of overlap with at least two partially overlapping portions. Outside of the at least two partially overlapping portions, the weld seam can then have portions that are not overlapping.

For example, at least one weld seam has several regions of overlap, wherein, in at least some of the several regions of overlap, at least two respective portions are formed so as to at least partially overlap. Outside of the at least two partially overlapping portions, the weld seam may have portions that are not overlapping.

In some advantageous embodiments, at least one of the following is provided:
that at least some of the flat components, in particular at least some of the welded flat components, each be a flat product;
   and/or
that the arrangement and/or the fuel-cell device comprise a flat member, in particular a bipolar plate and/or a membrane member, wherein the flat member is at least partially formed from at least some of the flat components, in particular at least some of the welded flat components, wherein the flat components of the at least one flat member are in particular flat products.

In particular, in at least one flat member, in particular a bipolar plate and/or a membrane member, flat components of the flat member, in particular flat products of the flat member, are advantageously at least partially welded together as explained above and/or, for example, below, so that the functionality of the flat member is advantageously improved and/or it can be manufactured more cost-effectively.

In some advantageous embodiments, at least one of the following is provided:
that at least some of the flat components, in particular at least some of the welded flat components, each be a flat member;
   and/or
that at least some of the flat components, in particular at least some of the welded flat components, at least co-form a stack of flat components arranged one above the other, wherein in particular the flat components in the stack are flat members.

Advantageously, at least some flat members, e.g., bipolar plates and/or membrane members, are at least partially welded together in the advantageous manner explained above and/or, for example, below, so that their interaction is advantageously improved. For example, the risk of leakage between the welded flat members can be reduced. For example, electrical conductivity between the welded flat members can be improved.

In particular, an interaction of the flat components, e.g., the flat members, in particular the bipolar plates and/or membrane members, in the stack is improved as explained above and/or below.

In particular, a weld seam with at least partially overlapping portions has an overlap sector in the region of overlap, wherein the overlap sector is formed by the overlapping subregions of the at least two at least partially overlapping portions.

No further details have been provided to date regarding advantageous designs of at least partially overlapping portions and/or advantageous designs of the overlap sector.

In particular, a weld seam has at least one seam portion running from a seam start to a seam end.

In some advantageous embodiments, at least one weld seam is formed from only one seam portion.

In some advantageous embodiments, at least one weld seam is composed of several seam portions. Advantageously, these several seam portions are formed in such a way that the seam portions form a continuous weld seam along their weld contour.

It is particularly advantageous if, in at least one region of overlap, at least one of the at least two overlapping portions is a seam start or a seam end of at least one seam portion of the weld seam.

In particular, in at least one region of overlap, the at least two at least partially overlapping portions are a seam start and/or a seam end, respectively.

For example, in at least one region of overlap, one of the at least two at least partially overlapping portions is a seam start, and the other of the at least two at least partially overlapping portions is a seam end of the same seam portion.

For example, in at least one region of overlap, an at least partially overlapping portion is a seam start or a seam end of a seam portion of the weld seam, and another of the at least partially overlapping portions is a seam start or a seam end of another seam portion of the weld seam.

This advantageously ensures that the weld seam is continuous and preferably fluid-tight even at the transition from a seam start and/or seam end to a seam start and/or seam end, and/or that the transition is designed to save space.

In particular, a weld seam has two longitudinal sides. Advantageously, at least most of the two longitudinal sides run along the weld contour, and each of the two longitudinal sides is formed on one side of the weld contour.

In particular, a weld seam, in particular each of its seam portions, has a seam width measured transversely to the weld contour and/or transversely to the direction of travel. In particular, the seam width of a weld seam and/or a seam portion corresponds to the distance between the two longitudinal sides of this weld seam and/or this seam portion.

For example, a seam width is at least substantially constant, at least in portions along the weld contour. For example, the seam width varies at least in portions along the weld contour.

For example, a seam width of a weld seam is at least 0.04 mm, preferably at least 0.07 mm, in particular at least 0.1 mm.

For example, a seam width of a weld seam is at most 0.5 mm, advantageously at most 0.4 mm, preferably at most 0.3 mm—for example, at most 0.2 mm.

In particular, a weld seam is formed along its weld contour transversely to the weld contour between its two longitudinal sides.

In particular, a seam portion has a terminating edge at its seam start and/or at its seam end. In particular, an elongated extension of a seam portion along the weld contour ends at a terminating edge.

In particular, the longitudinal sides of a seam portion run along the weld contour between the terminating edge at the seam start and the terminating edge at the seam end.

It is particularly advantageous if, in at least one region of overlap, a terminating edge of at least one portion of the at least two at least partially overlapping portions is formed at least partially in the other portion of the at least two at least partially overlapping portions of the weld seam.

This advantageously allows a space-saving formation of the weld seam even in the region of overlap.

For example, this makes it possible for seam irregularities that may occur in the region of the terminating edge to be compensated for and/or corrected by the formation of the other portion. This advantageously also ensures a good fluid-sealing effect of the weld seam in the region of overlap.

For example, in at least one region of overlap, at least two at least partially overlapping portions are formed transversely to the weld contour offset from one another, in particular only slightly offset from one another.

For example, a lateral offset between two at least partially overlapping portions amounts at least for the most part to at most 80%, in particular at most 60%, in particular at most 40%, e.g., at most 20%, of a seam width of at least one of the at least two portions formed offset from one another.

For example, a lateral offset between two portions formed offset from one another is at least for the most part at most 0.1 mm, preferably at most 0.08 mm, in particular at most 0.04 mm.

In some advantageous embodiments, at least one portion of a longitudinal side of a portion of the at least partially overlapping portions and at least one portion of a longitudinal side of another portion of the at least partially overlapping portions are formed so as to be at least substantially superimposed.

Preferably, in at least one region of overlap, an overlap width measured transversely to the weld contour is at least largely at least 10%, advantageously at least 30%, in particular at least 50%, e.g., at least 80%, of a seam width of at least one of the at least two at least partially overlapping portions.

For example, in at least one region of overlap, an overlap width measured transversely to the weld contour is at least largely at least 0.01 mm, preferably at least 0.03 mm, advantageously at least 0.05 mm. In particular, the overlap width, e.g., depending upon the formation of the weld seam, in particular depending upon the seam width of the weld seam, is advantageously at least 0.08 mm, in particular at least 0.1 mm.

In particular, the overlap width is the width of the overlap sector measured transversely to the weld contour.

In particular, the overlap width is measured between one longitudinal side of a portion of the at least two at least partially overlapping portions and another longitudinal side of a portion of the at least partially overlapping portions.

For example, in at least one region of overlap, the overlap width is at least substantially constant, at least in portions along the weld contour. For example, in at least one region of overlap, the overlap width varies at least in portions along the weld contour. In particular, it is provided that, in at least one region of overlap, at least one longitudinal side, advantageously both longitudinal sides, of a portion of the at least two at least partially overlapping portions and at least one longitudinal side, advantageously both longitudinal sides, of another portion of the at least two at least partially overlapping portions run at most slightly obliquely to one another and/or at most slightly obliquely to the course of the weld contour in the region of overlap. It is particularly advantageous if at least one longitudinal side, advantageously both longitudinal sides, of a portion of the at least two at least partially overlapping portions and at least one longitudinal side, advantageously both longitudinal sides, of another portion of the at least two at least partially overlapping portions run at least approximately parallel to one another and/or at least approximately parallel to the course of the weld contour in the region of overlap.

In particular, longitudinal sides which are at most slightly inclined to one another and/or the course of the weld contour form an angle of at most 50°, in particular of at most 40°, advantageously of at most 30°.

In particular, in at least one region of overlap, at least one longitudinal side of at least one portion of the at least two at least partially overlapping portions is at least partially formed in another portion of the at least two at least partially overlapping portions of the weld seam.

In some advantageous embodiments, in at least one region of overlap, an overlap sector of the at least two at least partially overlapping portions is delimited at least in portions along the weld contour transversely to the weld contour on one side by a longitudinal side of a portion of the at least two portions, and on the other side by a longitudinal side of another portion of the at least two portions.

Advantageously, it is provided that, in at least one region of overlap, an overlap length of the at least two at least partially overlapping portions be at least 0.05 mm, preferably at least 0.1 mm—for example, at least 0.5 mm.

For example, in at least one region of overlap, an overlap length is at most 20 mm, advantageously at most 10 mm, e.g., at most 5 mm, e.g., at most 2 mm.

Preferably, in at least one region of overlap, an overlap length of the at least two at least partially overlapping portions is at least as large as a seam width of at least one portion of the at least two portions, and preferably the overlap length is at least twice as large as the seam width.

In particular, the overlap length is measured at least approximately perpendicular to the overlap width.

In particular, the overlap length is measured at least substantially along the course of the weld contour.

In particular, the overlap length is the length of the overlap sector of the at least two at least partially overlapping portions.

In advantageous embodiments, the overlap sector of the at least two at least partially overlapping portions is elongated in at least one region of overlap. In particular, the elongated overlap sector has, in a direction of an elongated extension, an extension which is greater, e.g., at least twice as large, than an extension of the overlap sector at least approximately perpendicular to the direction of the elongated extension.

Preferably, the direction of the elongated extension of the overlap sector is at most slightly oblique and preferably at least approximately parallel to the course of the weld contour in the region of overlap. Advantageously, the at most slightly oblique direction of the elongated extension and the course of the weld contour form an angle of at most 50°, preferably of at most 40°—for example, of at most 30°.

In particularly advantageous embodiments, at least one portion, i.e., in particular exactly one portion or at least some portions, of the at least two at least partially overlapping portions of the weld seam has a ramp portion in at least one region of overlap.

In the ramp portion, a penetration depth of the weld formation of the at least one portion is smaller than, in particular, a typical penetration depth in the at least one portion outside the ramp portion. In particular, the penetration depth in the ramp portion is smaller than an, in particular, typical penetration depth of the weld seam outside the region of overlap.

In particular, the in particular typical penetration depth, with respect to which the penetration depth in the ramp portion is smaller, is a penetration depth which is formed at least largely outside the ramp portion in the at least one portion and/or a penetration depth averaged outside the ramp portion in the portion which has the ramp portion.

For example, the in particular typical penetration depth, with respect to which the penetration depth in the ramp portion is smaller, is a penetration depth which is at least largely formed in the weld seam outside the region of overlap and/or a penetration depth of the weld seam averaged outside the region of overlap.

In particular, in the ramp portion, a thickness of a weld formation of the portion is thus smaller than an in particular typical thickness of the weld formation in the portion outside the ramp portion and/or smaller than an in particular typical thickness of the weld formation in the weld seam outside the region of overlap.

In particular, a ramp portion of at least one portion is formed at least partially and preferably at least largely to overlap with another of the at least two at least partially overlapping portions.

In particular, one advantage of a ramp portion is that it can be formed to overlap with another portion, and thus the weld seam can be formed continuously, but, due to the smaller penetration depth in the ramp portion, the weld seam reinforcement in the overlap sector does not become too large.

Advantageously, the weld reinforcement in the region of the ramp portion is at most the same size as typically at least largely along the weld seam, and, for example, the weld reinforcement is smaller in a ramp portion. For example, a weld reinforcement becomes smaller with increasing extension of the ramp portion, in particular due to the smaller penetration depth in the ramp portion and/or due to a decreasing penetration depth in the ramp portion.

In particular, a ramp portion is formed at a seam start and/or at a seam end.

Advantageously, by forming a ramp portion at a seam start and/or at a seam end, seam irregularities, which occur in particular at a start and/or an end of a seam portion, can be at least reduced and in particular at least largely avoided, thereby ensuring the function of the seam.

For example, splashes from the material to be welded can occur at the seam start due to the start of welding—for example, due to the first entry of a welding laser during laser welding. In particular, such material splashes impair the reliable functioning of the flat component and contradict cleanliness requirements.

For example, end craters can occur at a seam end in the material to be welded-in this case in the flat component. For example, end craters form during laser welding due to the collapse of the vapor capillary when the laser is switched off. Such end craters can impair the functionality of the flat component. In particular, such end craters can lead to leaks. In unfavorable cases, such end craters can completely penetrate a flat component.

Such seam irregularities can be advantageously at least reduced by a ramp portion, because, at the seam start, for example, a weld formation is slowly increased, and/or, at a seam end, for example, the weld formation is slowly reduced, and thus at least the extent of the seam irregularities is reduced.

In advantageous embodiments, at least one of the following is provided:
that, in at least one ramp portion, the penetration depth change in steps, at least in portions—for example, with an increasing extension of the ramp portion;
   and/or
that, in at least one ramp portion, the penetration depth change continuously, at least in portions, with an increasing extension of the ramp portion;
   and/or
that, in at least one ramp portion, the penetration depth change at least in portions at least substantially linearly with an increasing extension of the ramp portion;
   and/or
that, in at least one ramp portion, the penetration depth change at least in portions increasingly and/or decreasingly with an increasing extension of the ramp portion, i.e., in particular that the penetration depth change at least in portions more than linearly and/or less than linearly.

For example, in the case of a step-like change in the penetration depth at least in portions, it is provided that, in the portion, at least at one step, the penetration depth change at least substantially abruptly.

For example, the penetration depth at a step changes from the unreduced penetration depth in the portion, i.e., for example, from the typical penetration depth, to a smaller penetration depth in the ramp portion.

For example, the penetration depth changes at at least one step within the ramp portion from a first smaller penetration depth to a second smaller penetration depth, wherein the second smaller penetration depth is smaller than the first smaller penetration depth.

For example, a step is provided, in particular at a terminating edge, at which a smaller penetration depth in the ramp portion changes abruptly to zero, so that the portion ends at this step.

For example, a ramp portion of one portion is merely designed to overlap with a ramp portion of another portion.

For example, a ramp portion of a portion overlaps at least partially with another portion in a region in which the other portion has its typical penetration depth.

In particular, it is provided that, in at least one region of overlap, at least two portions of the weld seam be formed so as to at least partially overlap with their respective ramp portions.

Ideally, at least one of the following is provided:
that, in at least one region of overlap, the at least two portions be formed to overlap only with their respective ramp portions;
   and/or
that, in at least one region of overlap, at least one of the at least two portions be formed to at least partially overlap with its ramp portion at least one other portion outside the ramp portion of the other portion;
   and/or
that, in at least one region of overlap, the at least two portions of the weld seam be formed to partially overlap outside their ramp portions.

In advantageous embodiments, it is provided that, in at least one region of overlap and in particular in the overlap sector of the at least two at least partially overlapping portions, a seam elevation of the weld seam above a geometric reference plane defined by the surroundings of the weld seam be at most 0.08 mm, preferably at most 0.05 mm, in particular at most 0.03 mm, e.g., at most 0.02 mm, advantageously at most 0.01 mm.

In particular, a low weld reinforcement is achieved by forming at least one ramp portion.

It is particularly advantageous if at least one weld seam with at least two at least partially overlapping portions has at least one circumferentially self-contained, at least partial, course.

In particular, at least one weld seam with at least two at least partially overlapping portions is a sealing weld seam, and at least one circumferentially self-contained, at least partial, course of the sealing weld seam surrounds a region to be sealed in a closed manner on the circumferential side.

In particular, at least one region of overlap is formed with at least two at least partially overlapping portions in at least one circumferentially self-contained, at least partial, course of the weld seam.

For example, the circumferentially self-contained, at least partial, course is only a part of the entire course of the weld seam, and/or the entire course of the weld seam is circumferentially self-contained and forms, for example, the circumferentially self-contained, at least partial, course.

In particular, the provision of a region of overlap with at least two at least partially overlapping portions in a circumferentially self-contained course of the weld seam and/or in the case of a sealing weld seam is particularly advantageous, because in this way the course can be designed to be closed in an advantageous manner, in particular with the advantages explained, and/or the sealing weld seam can be designed to be particularly advantageous in a fluid-tight manner in the region of overlap.

The flat components can be a wide variety of flat components.

In advantageous embodiments, at least one of the following is provided:
that at least one flat component of the several flat components, in particular at least one and preferably at least some of the welded flat components, be at least partially formed from a metallic material;
   and/or
that at least one flat component of the several flat components, in particular at least one and preferably at least some of the welded flat components, be part of an electrical device and in particular be an electrode layer;
   and/or
that at least one flat component, in particular at least one and preferably at least some of the welded flat components, at least co-form line portions of a line system for at least one fluid medium.

The advantages explained are particularly effective here, because the formation of the at least one weld seam in the at least one region of overlap advantageously improves electrical conductivity and/or sealing by the weld seam.

In particular, the at least one and/or at least some of the welded flat components is/are formed from a metallic material, at least in their portions in which they are welded together.

In embodiments of the invention, the initially mentioned underlying object is achieved by a method for producing an arrangement comprising several flat components, wherein the method comprises at least the following steps:
providing several flat components;
welding together at least two flat components of the several flat components by at least one weld seam running along a weld contour;
welding at least two portions of a weld seam, wherein, in at least one region of overlap, the at least two portions of the weld seam are welded so as to at least partially overlap along their weld contour.

In embodiments of the invention, the initially mentioned underlying object is achieved by a method for producing a fuel-cell device, wherein the method comprises at least the following steps:
providing several flat components;
welding together at least two flat components of the several flat components by at least one weld seam running along a weld contour;
welding at least two portions of a weld seam, wherein, in at least one region of overlap, the at least two portions of the weld seam are welded so as to at least partially overlap along their weld contour.

In particular, at least one weld seam can be formed more efficiently, and, advantageously, there is less waste during the manufacture of the arrangement and/or the fuel-cell device.

In particular, the advantages explained above and/or below also apply to the methods, so that, in order to avoid repetition, reference is made in full to the above and/or following embodiments.

In particular, advantageous methods are used to produce an arrangement and/or a fuel-cell device having at least one of the features explained above and/or below and advantageously having a combination of at least some of these features, and the method comprises at least one corresponding method step. In order to avoid repetition, reference is made in full to the preceding and/or following explanations.

Advantageously, an assembly and/or a fuel-cell device is manufactured using one of the methods explained above and/or below.

Thus, explanations in connection with the method on the one hand and/or with the arrangement and/or fuel-cell device on the other also relate to advantageous embodiments of the arrangement and/or the fuel-cell device or corresponding method steps in the methods.

A wide variety of welding methods can be used for welding.

In advantageous embodiments, at least one weld seam is welded by laser welding.

In advantageous embodiments, it is provided that at least one seam start and/or one seam end of a seam portion of a weld seam be welded so as to at least partially overlap with a seam start and/or a seam end of a seam portion of the weld seam in a region of overlap.

For example, in the case of an identical seam portion, its seam end is welded with at least a partial overlap with its seam start.

For example, in the case of different seam portions, a seam start and/or a seam end of a seam portion is welded so as to at least partially overlap with a seam start and/or a seam end of another seam portion.

In advantageous embodiments, at least one portion of at least two at least partially overlapping portions of a weld seam is welded with a ramp portion in at least one region of overlap, wherein, in the ramp portion, a penetration depth of the weld seam is smaller than an in particular typical penetration depth in the portion outside the ramp portion.

Advantageously, when welding a ramp portion, the energy introduced per distance is reduced, and, advantageously, increasingly reduced with increasing extension of the ramp portion.

In particular, at least one of the following is provided:
that at least one ramp portion be formed at least partially by a power regulation during welding;
   and/or
that at least one ramp portion be formed at least partially by a change in a relative movement between the flat components to be welded together on the one hand and a welding device, in particular a laser beam, on the other;
   and/or
that at least one ramp portion be formed at least partially by defocusing a welding laser beam
for example, by shifting the laser beam focus;
   and/or
that at least one ramp portion be formed at least partially by widening a diameter of a welding laser beam.

Advantageously, a combination of measures is used—for example, at least a power regulation and a change in the relative movement.

For example, during the power regulation, to form the ramp portion, the power is at least partially reduced to below 50% of an in particular typical power which is used when welding outside the ramp portion and in particular outside the region of overlap. For example, a power when welding the ramp portion is at least approximately between 10% and 50% of the typical power for welding outside the ramp portion and in particular outside the region of overlap.

For example, the relative movement is increased, to form at least one ramp portion, in particular by at least 20%, in particular by at least 50%—for example, by at least 100%.

In some advantageous embodiments, this relative movement is increased by at least 300%—for example, by at least 500%.

Advantageously, these measures, in particular a combination thereof, can at least reduce the risk of weld seam irregularities, and, advantageously, at least almost no weld seam irregularities occur.

In particular, beam guidance optics are used to guide at least one laser beam for welding. For example, the optics include at least one scanner optic.

For example, several laser beams can be guided through the steel guidance optics, so that several seam portions of the same weld seam and/or of different weld seams can be welded simultaneously.

For example, the beam guidance optics comprise at least one beam splitter to divide at least one laser beam into several laser beams.

For example, several lasers with respective optical units, e.g., comprising at least one scanner optic, are provided.

Advantageously, several seam portions of the same weld seam and/or of different weld seams can be welded simultaneously.

Advantageously, at least one laser beam can be modified by the beam guidance optics, e.g., its focus can be modified and/or its diameter can be modified—for example, to form at least one ramp portion.

For example, power regulation and/or adjustment of at least one welding laser beam is carried out by a system technology and/or by the beam guidance optics.

For example, at least two seam portions, in particular of the same weld seam and/or of different weld seams, are welded in immediately subsequent welding processes.

Advantageously, several seam portions, in particular of the same weld seam and/or of different weld seams, are welded with the same clamping of the flat components to be welded together, wherein in particular the clamping is carried out by at least one hold-down device.

For example, at least two seam portions, in particular of the same weld seam and/or of different weld seams, are welded in at least two different welding processes.

In some advantageous embodiments, at least one further clamping of the flat components to be welded together takes place between the welding of at least two seam portions, in particular of the same weld seam and/or of different weld seams.

For example, one clamping operation and/or several clamping operations at different times of the flat components to be welded together and/or at least some formation of several seam portions is accomplished in the same welding tool.

For example, at least some of the different welding processes are clamped using different hold-down devices.

In some advantageous embodiments, it is provided that at least one weld seam with at least two portions that at least partially overlap in at least one region of overlap be completed in the same welding tool.

In some advantageous embodiments, at least some of several weld portions, in particular of the same weld seam and/or of different weld seams, are produced in different welding tools.

Above and below, it is to be understood in particular that, for example, deviations of up to ±20%, preferably of up to ±10%, e.g., of up to ±5%, are included, and/or that the feature is at least substantially provided, in the case of features that are at least approximately provided.

Above and below, it is to be understood in particular that, in the case of features that are at least substantially provided, deviations that are technically caused and/or not technically relevant are included, and/or that deviations of up to ±5% are included.

Above and below, the wording that a feature is provided at least for the most part in an entity, e.g., that a feature is provided at least for a large part of elements of a total quantity and/or at least for the most part along a length, is to be understood in particular as meaning that the feature is provided in at least half, preferably at least 70% and in particular at least 80%, e.g., at least 90%, of the entity, i.e., for example, the total number and/or the length, and/or that, for example, the feature is provided at least substantially in the entity, i.e., in particular within technically determined and/or technically irrelevant tolerances.

Above and below, elements and features which are described as for example and/or in particular and/or preferably and/or expediently and/or in particular in a preferred manner and/or provided in variants and/or the like are optional features which, for example, represent developments of the invention, but are not absolutely necessary for the success of the basic solution according to the invention.

Preferred embodiments and features of the invention and, for example, advantages thereof are the subject of the following detailed description and the illustrated representation of an exemplary embodiment in different variants.

The description of solutions according to the invention thus comprises in particular the various feature combinations defined by the following numbered embodiments:
1. An arrangement comprising several flat components (125, 143, 144, 252), in particular for a fuel-cell device (100), wherein at least two flat components (125, 143, 144, 252) are welded together by at least one weld seam (312) which runs along a weld contour (316), and wherein, in at least one weld seam (312), at least two portions (356) of the weld seam (312) are formed to at least partially overlap in a region of overlap (352) along the weld contour (316).
2. A fuel-cell device (100) comprising several flat components (125, 143, 144, 252), wherein at least two flat components (125, 143, 144, 252) are welded together by at least one weld seam (312) which runs along a weld contour (316), and wherein, in at least one weld seam (312), at least two portions (356) of the weld seam (312) are formed so as to at least partially overlap in a region of overlap (352) along the weld contour (316).
3. The arrangement according to embodiment 1 and/or fuel-cell device (100) according to embodiment 2 characterized by at least one of the following:
that at least some of the flat components (125, 143, 144, 252), in particular at least some of the welded flat components (125, 143, 144, 252), are each a flat product (252);
   and/or
that the arrangement and/or the fuel-cell device (100) comprises a flat member (125, 143, 144), in particular a bipolar plate (143), wherein the flat member (125, 143, 144) is at least partially formed from at least some of the flat components (125, 143, 144, 252), in particular from at least some of the welded flat components (125, 143, 144, 252).
4. The arrangement and/or fuel-cell device (100) according to one of the preceding embodiments, wherein at least one of the following is provided:
that at least some of the flat components (125, 143, 144, 252), in particular at least some of the welded flat components (125, 143, 144, 252), each be a flat member (125, 143, 144);
   and/or
that at least some of the flat components (125, 143, 144, 252), in particular at least some of the welded flat components (125, 143, 144, 252), at least co-form a stack (127) of flat components (125, 143, 144, 252) arranged one above the other.
5. The arrangement and/or fuel-cell device (100) according to one of the preceding embodiments, wherein, in at least one region of overlap (352), at least one of the at least two at least partially overlapping portions (356) is a seam start (326) or a seam end (328) of at least one seam portion of the weld seam (312), in particular that the at least two at least partially overlapping portions (356) are a seam start (326) and/or a seam end (328), respectively.
6. The arrangement and/or fuel-cell device (100) according to one of the preceding embodiments, wherein, in at least one region of overlap (352), a terminating edge (332) of at least one portion (356) of the at least two at least partially overlapping portions (356) is formed at least partially in another portion (356) of the at least two at least partially overlapping portions (356) of the weld seam (312).
7. The arrangement and/or fuel-cell device (100) according to one of the preceding embodiments, wherein, in at least one region of overlap (352), an overlap width (368), which is measured transversely to the weld contour (316), is at least largely at least 10%, in particular at least 30%, in particular at least 50%, in particular at least 80%, of a seam width (322) of at least one of the at least two overlapping portions (356).
8. The arrangement and/or fuel-cell device (100) according to one of the preceding embodiments, wherein, in at least one region of overlap (352), at least one longitudinal side (334, 336) of a portion (356) of the at least two at least partially overlapping portions (356) and at least one longitudinal side (334, 336) of another portion (356) of the at least two at least partially overlapping portions (356) run at most slightly obliquely to one another and/or at most slightly obliquely to the profile of the weld contour (316) in the region of overlap (352).
9. The arrangement and/or fuel-cell device (100) according to one of the preceding embodiments, wherein, in at least one region of overlap (352), an overlap sector (362) of the at least two at least partially overlapping portions (352) is delimited at least in portions along the weld contour (316) transversely to the weld contour (316) on one side by a longitudinal side (334, 336) of a portion (356) of the at least two portions (356) and is delimited on the other side by a longitudinal side (334, 336) of another portion (356) of the at least two portions.
10. The arrangement and/or fuel-cell device (100) according to one of the preceding embodiments, wherein, in at least one region of overlap (352), the overlap sector (362) of the at least two at least partially overlapping portions (356) is elongated, and in particular a direction of the elongated extent of the overlap sector (362) runs at most slightly obliquely, in particular at least approximately parallel, to the profile of the weld contour (316) in the region of overlap (352).
11. The arrangement and/or fuel-cell device (100) according to one of the preceding embodiments, wherein, in at least one region of overlap (352), at least one portion (356) of the at least two at least partially overlapping portions (356) of the weld seam (312) has a ramp portion (382), wherein, in the ramp portion (382), a penetration depth (386) of the weld formation (312) of the at least one portion (356) is smaller than an in particular typical penetration depth (386) in the at least one portion (356) outside the ramp portion (382).
12. The arrangement and/or fuel-cell device (100) according to one of the preceding embodiments, wherein at least one of the following is provided:
that, in at least one ramp portion (382), the penetration depth (386) change in a step-like manner at least in portions;
   and/or
that, in at least one ramp portion (382), the penetration depth (386) change continuously at least in portions with an increasing extension of the ramp portion (382);
   and/or
that, in at least one ramp portion (382), the penetration depth (386) change at least in portions at least substantially linearly with an increasing extension of the ramp portion (382);
   and/or
that, in at least one ramp portion (382), the penetration depth (386) change at least in portions increasingly and/or decreasingly with an increasing extension of the ramp portion (382).
13. The arrangement and/or fuel-cell device (100) according to one of the two preceding embodiments, wherein, in at least one region of overlap (352), at least two portions (356) of the weld seam (312) are formed to at least partially overlap with their respective ramp portions (382),
   wherein in particular at least one of the following is provided:
that, in at least one region of overlap (352), the at least two portions (356) be formed to overlap only with their respective ramp portions (382);
   and/or
that, in at least one region of overlap (352), at least one of the at least two portions (356) be formed to at least partially overlap with its ramp portion (382) at least one other portion (356) outside the ramp portion (382) of the other portion (356);
   and/or
that, in at least one region of overlap (352), the at least two portions (356) of the weld seam (312) be formed to partially overlap outside their ramp portions (382).
14. The arrangement and/or fuel-cell device (100) according to one of the preceding embodiments, wherein, in at least one region of overlap (352), in particular in the overlap sector (362) of the at least two at least partially overlapping portions (356), a seam elevation of the weld seam (312) above a geometric reference plane defined by the surroundings of the weld seam (312) is at most 0.08 mm, in particular at most 0.05 mm, in particular at most 0.03 mm, in particular at most 0.01 mm.
15. The arrangement and/or fuel-cell device (100) according to one of the preceding embodiments, wherein at least one weld seam (312) with at least two at least partially overlapping portions (356) has at least one circumferentially self-contained, at least partial, course, and in particular the weld seam (312) is a sealing weld seam, and the circumferentially self-contained, at least partial, course surrounds a region to be sealed in a circumferentially closed manner.
16. The arrangement and/or fuel-cell device (100) according to one of the preceding embodiments, wherein at least one of the following is provided:
that at least one of the welded flat components (125, 143, 144, 252) be at least partially formed from a metallic material;
   and/or
that at least one flat component (125, 143, 144, 252), in particular at least one of the welded flat components (125, 143, 144, 152), be part of an electrical device, in particular is an electrode layer;
   and/or
that at least one flat component (125, 143, 144, 252), in particular at least one of the welded flat components (125, 143, 144, 252), at least co-form at least line portions of a line system (112) for at least one fluid medium.
17. A method for producing an arrangement comprising several flat components (125, 143, 144, 252), wherein the method comprises at least the following steps:
providing several flat components (125, 143, 144, 252);
welding together at least two flat components (125, 143, 144, 252) of the several flat components (125, 143, 144, 252) by at least one weld seam (312) running along a weld contour (316);
welding at least two portions (356) of a weld seam (312), wherein, in at least one region of overlap (352), the at least two portions (356) of the weld seam (312) are welded so as to at least partially overlap along their weld contour (316).
18. A method for producing a fuel-cell device (100), wherein the method comprises at least the following steps:
providing several flat components (125, 143, 144, 252);
welding together at least two flat components (125, 143, 144, 252) of the several flat components (125, 143, 144, 252) by at least one weld seam (312) running along a weld contour (316);
welding at least two portions (356) of a weld seam (312), wherein, in at least one region of overlap (352), the at least two portions (356) of the weld seam (312) are welded so as to at least partially overlap along their weld contour (316).
19. The method according to one of the preceding embodiments directed at a method, wherein at least one seam start (326) and/or one seam end (328) of a seam portion of a weld seam (312) is welded in a region of overlap (352) so as to at least partially overlap with a seam start (326) and/or one seam end (328) of a seam portion of the weld seam (312).
20. The method according to one of the preceding embodiments directed at a method, wherein, at least in a region of overlap (352), at least one portion (356) of at least two at least partially overlapping portions (356) of a weld seam (312) is welded to a ramp portion (382), wherein, in the ramp portion (382), a penetration depth (386) of the weld formation is smaller than an in particular typical penetration depth (386) in the portion (356) outside the ramp portion (382),
   wherein in particular at least one of the following is provided:
that at least one ramp portion (382) be formed at least partially by a power regulation during welding;
   and/or
that at least one ramp portion (382) be formed at least partially by changing a relative movement between the flat components (125, 143, 144, 252) to be welded together, on the one hand, and a welding device, in particular a laser beam, on the other hand; and/or
that at least one ramp portion (382) be formed at least partially by defocusing a welding laser beam;
   and/or
that at least one ramp portion (382) be formed at least partially by widening a diameter of a welding laser beam.

The following detailed description and the graphic representation of an exemplary embodiment relate to preferred features and advantages of the invention.

In the drawings:

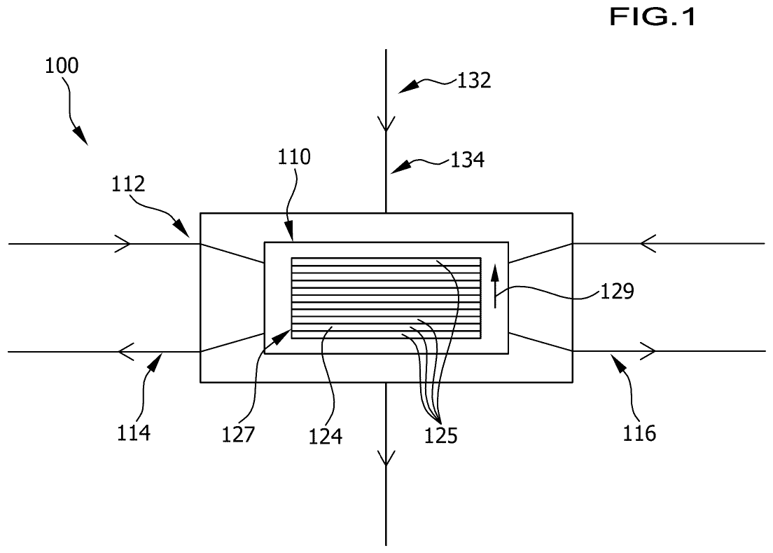

FIG. 1 is a schematic view of an exemplary embodiment of a fuel-cell device which comprises at least one fuel-cell unit having a stack of several flat members;

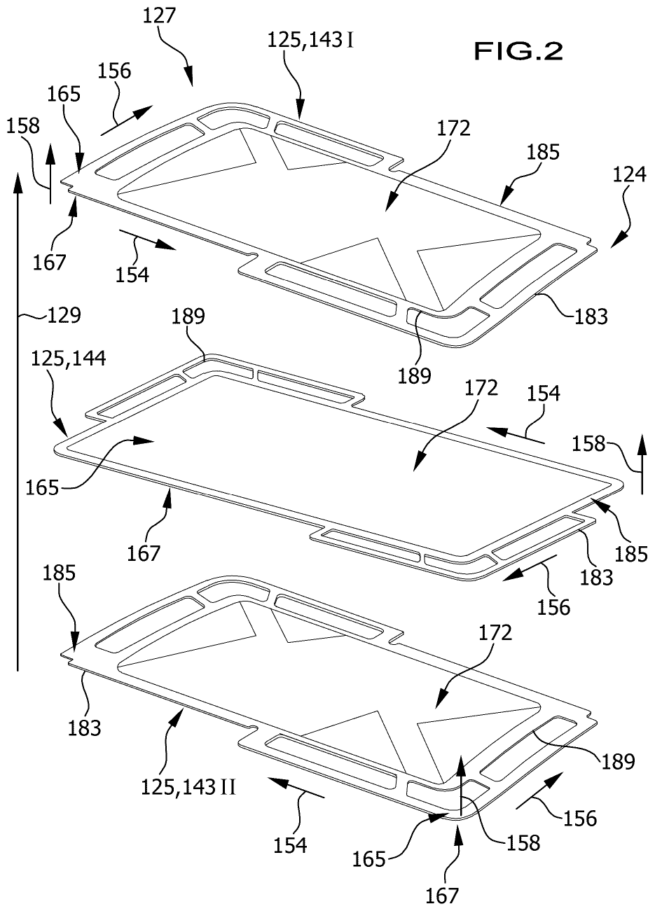

FIG. 2 shows several flat members to be arranged on top of one another for the stack;

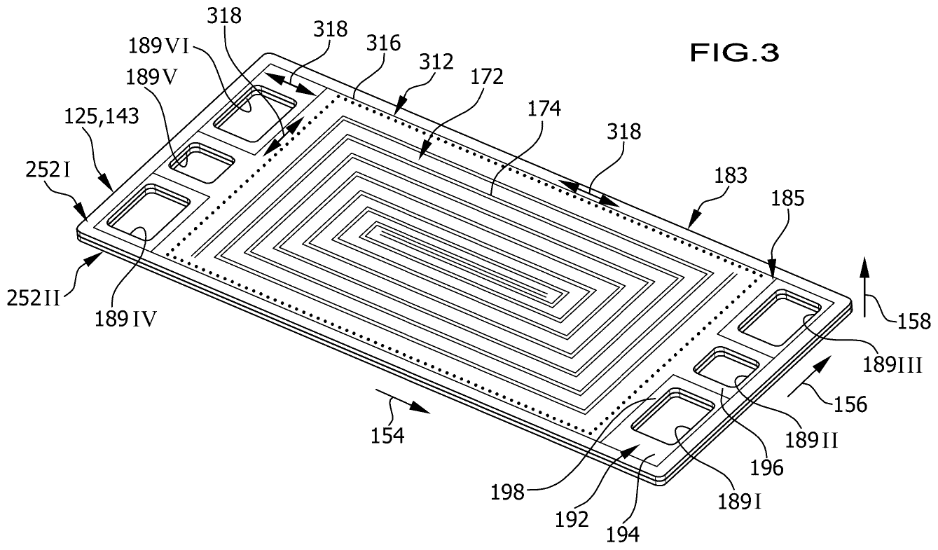

FIG. 3 is an oblique plan view of a flat member formed from several flat products;

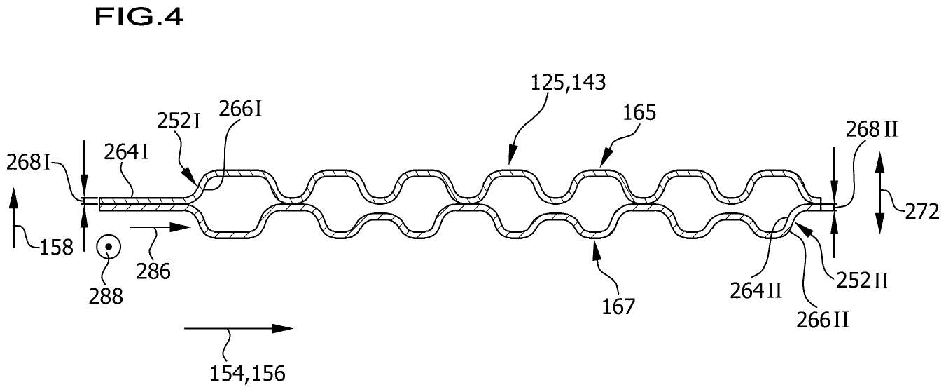

FIG. 4 is a sectional view of a flat member formed from several flat products in the region of a functional region provided with structures;

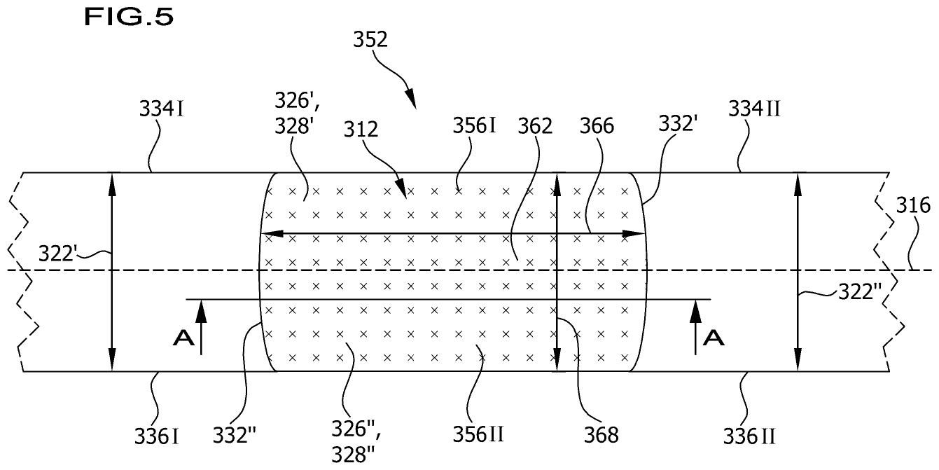

FIG. 5 is a plan view of a variant of a region of overlap of a weld seam;

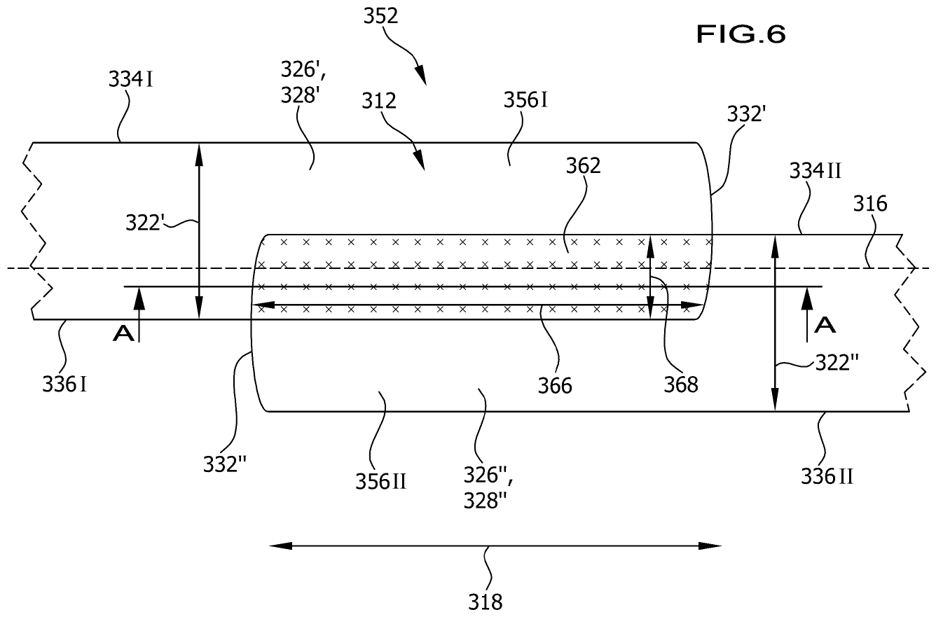

FIG. 6 is a plan view of a further variant of a region of overlap of a weld seam;

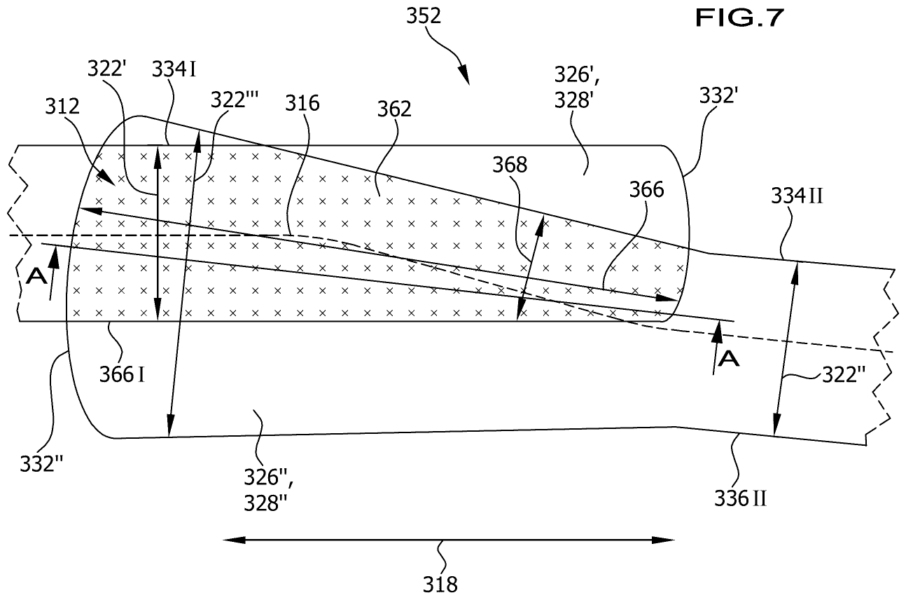

FIG. 7 is a plan view of yet another variant of a region of overlap of a weld seam;

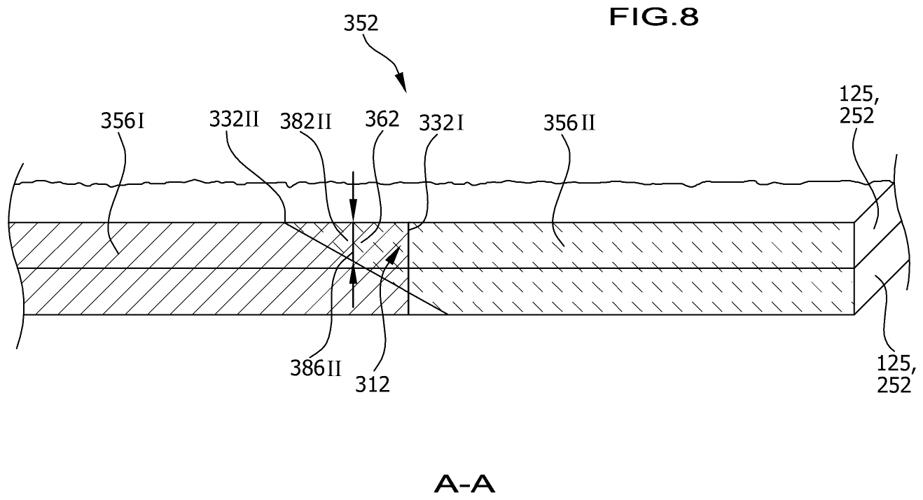

FIG. 8 is a sectional view through a variant of a region of overlap of a weld seam;

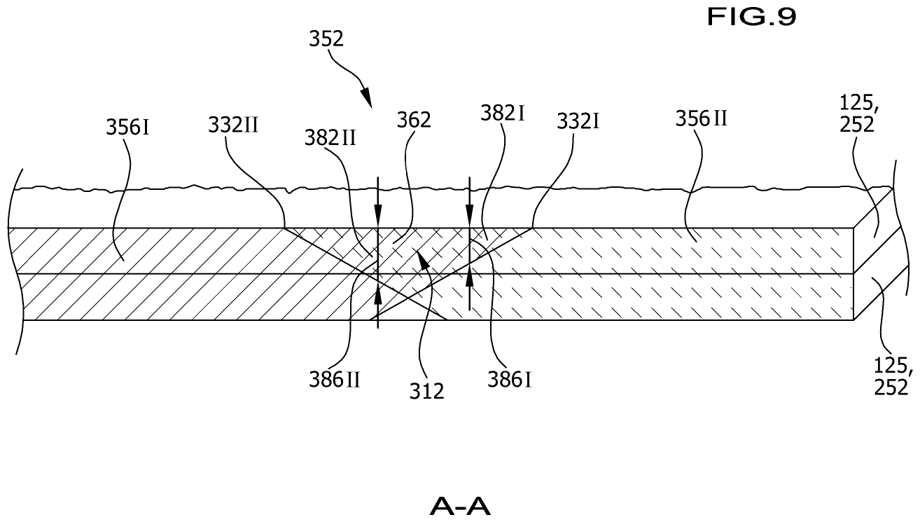

FIG. 9 is a sectional view through another variant of a region of overlap of a weld seam;

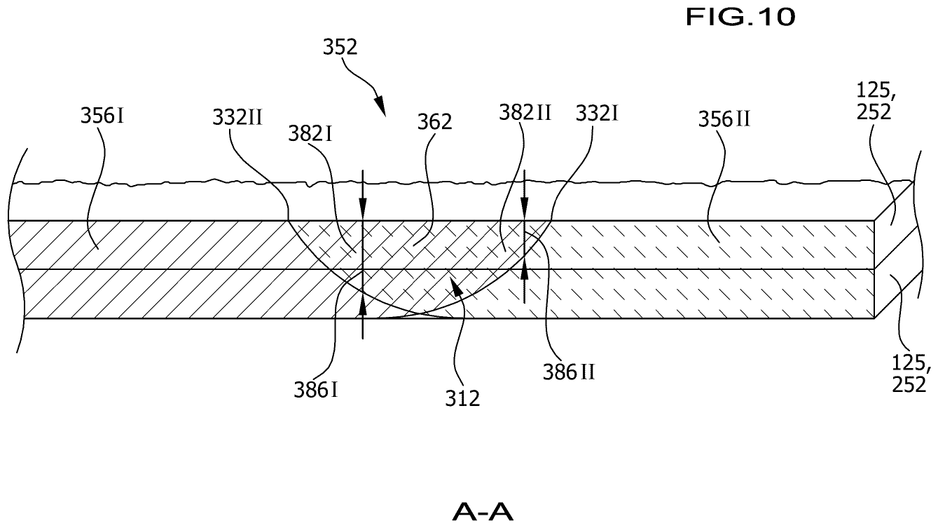

FIG. 10 is a sectional view through yet another variant of a region of overlap of a weld seam;

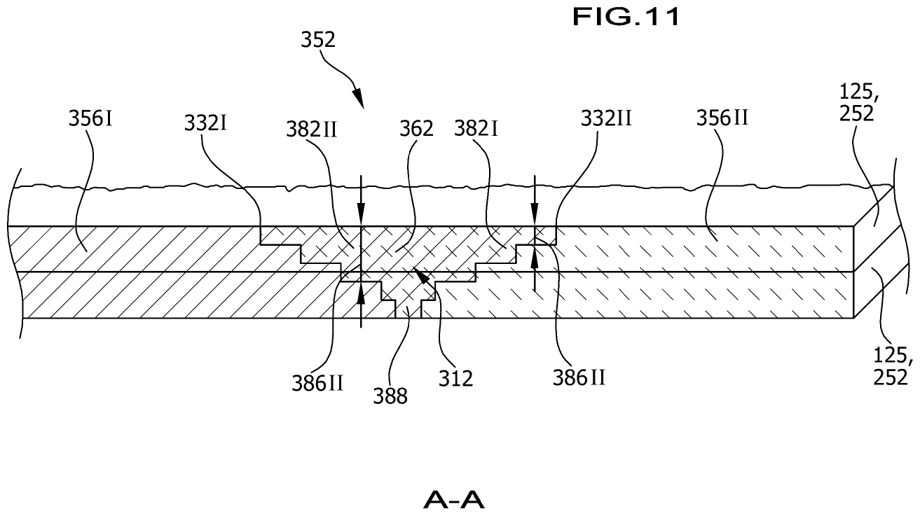

FIG. 11 is a sectional view through yet another variant of a region of overlap of a weld seam; and

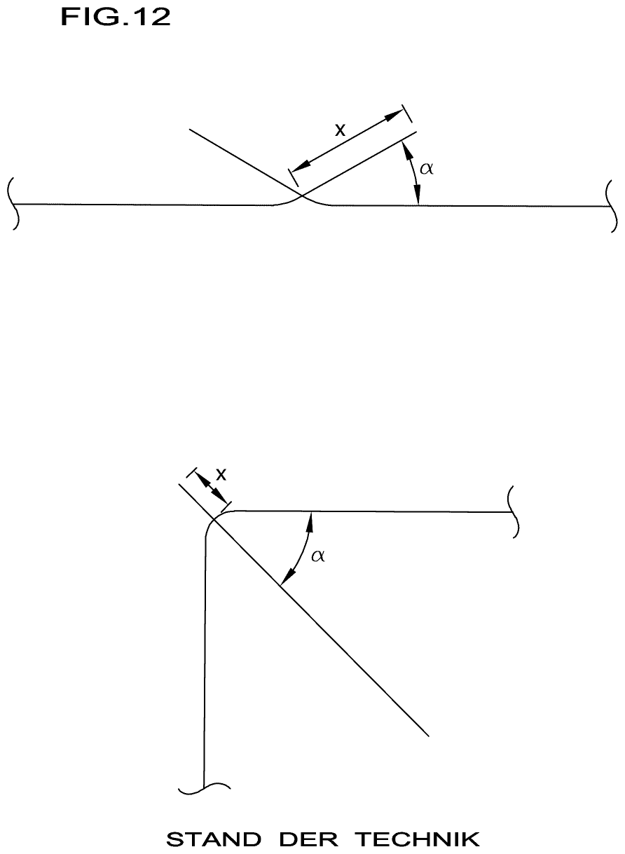

FIG. 12 shows representations of a weld seam with intersecting portions from the prior art.

An exemplary embodiment of a fuel-cell device designated as a whole by 100 comprises at least one fuel-cell unit 110 and in particular a line system designated as a whole by 112 having at least one line apparatus 114 for a fuel medium and a line apparatus 116 for an oxidation medium, wherein the line apparatuses 114, 116 are connected to the at least one fuel-cell unit 110 and partially formed therein, as schematically shown by way of example in FIG. 1.

The at least one fuel-cell unit 110 comprises several cell units 124, wherein the fuel medium and the oxidation medium are at least partially chemically converted into a product medium in the cell units, and in particular electrical energy is provided in the process.

In particular, the cell units 124 are connected in series.

The cell units 124 are formed from flat members 125, and the flat members 125 are arranged on top of one another in a stacking direction 129 in a stack 127.

By means of the line apparatus 114 for the fuel medium, the fuel medium can be supplied to an anode side of the fuel-cell unit 110 and to the individual cell units 124, in particular as a constituent of an anode fluid mixture, and a residual anode fluid mixture, which in particular comprises fuel medium portions and/or portions of the product medium and/or components of the supplied anode fluid mixture that are supplied to the at least one fuel-cell unit 110 but not chemically converted therein, can be discharged again from the cell units 124 and from the at least one fuel-cell unit 110.

By means of the line apparatus 116 for the oxidation medium, the oxidation medium can be supplied, in particular as a constituent of a cathode fluid mixture, to at least one fuel-cell unit 110 and to the individual cell units 124, and a residual cathode fluid mixture, which in particular comprises oxidation medium portions and/or portions of the product medium and/or portions of the supplied cathode fluid mixture that are supplied to the at least one fuel-cell unit 110 but not chemically converted therein, can be discharged again from the cell units 124 and from the at least one fuel-cell unit 110.

For example, a temperature-control apparatus 132 is also provided to keep the at least one fuel-cell unit 110 within a temperature range permissible for proper operation thereof.

Preferably, the temperature-control apparatus 132 is designed for cooling and/or heating the at least one fuel-cell unit 110 as required, in particular depending upon an operating state of the fuel-cell device.

In particular, the temperature-control apparatus 132 comprises, as part of the line system 112, a line apparatus 134 for a temperature-control medium for supplying a temperature-control medium to the fuel-cell unit 110 and to the individual cell units 124 and for discharging the temperature-control medium from the individual cell units 124 and from the at least one fuel-cell unit 110, wherein the temperature-control medium is in heat-exchanging contact with the fuel-cell unit 110, in particular with the individual cell units 124, advantageously with the several flat members 125, after being supplied and before being discharged.

In particular, the several flat members 125 comprise flat components designed as bipolar plates 143 and in particular at least some flat members designed as membrane members 144.

In particular, as shown by way of example in an exploded view in FIG. 2, a flat member designed as a membrane member 144 is arranged between each two flat components designed as bipolar plates 143, here for example between the two bipolar plates 1431 and 143II, which collectively thus at least co-form a cell unit 124 in each case.

In particular, adjacent flat members 125, e.g., a bipolar plate 143 and a membrane member 144, are rigidly connected to one another, preferably so as to be fluid-tight, at least in portions.

For example, at least two flat members 125 are welded together with at least one weld seam. Advantageously, at least one weld seam is a sealing weld seam, wherein at least a partial course of the sealing weld seam surrounds a region to be sealed in a circumferentially closed manner.

Preferably, at least one weld seam, in particular at least one sealing weld seam, is formed as explained below.

Advantageously, a seal is formed at least between adjacent flat members 125, in particular between a bipolar plate 143 and a membrane member 144, which seal is, for example, over-molded and/or has a sealing cord and/or is applied by screen printing.

In particular, two bipolar plates 143 form at least one reaction chamber in each case, in which a membrane of a membrane member 144, which is arranged between the two bipolar plates 143, advantageously extends, wherein oxidation medium and fuel medium fed into the reaction chamber react chemically, and electrical energy is provided during the chemical reaction.

Advantageously, the bipolar plates 143 are designed as an anode or cathode for a single cell unit 124.

In particular, the fuel medium is fed into a part of the reaction chamber delimited by the membrane of the membrane member 144 and by one of the two bipolar plates 143, and the oxidation medium is fed into a part of the reaction chamber delimited by the membrane of the membrane member 144 and the other of the two bipolar plates 143. The fuel medium and the oxidation medium interact via the membrane; in particular, charged particles pass through the membrane from one part of the reaction chamber to the other part of the reaction chamber, and particles of opposite charge pass via an electrical circuit from one part of the reaction chamber to the other part of the reaction chamber.

In particular, the surface of each of the flat members 125 extends in two areal extension directions 154 and 156 which are at least substantially perpendicular to one another and which span a geometric areal extension plane in each case.

Typically, the areal extension planes of the plurality of flat members 125 when stacked on top of one another in the stack 127 run at least substantially in parallel with one another and at least substantially perpendicularly to the stacking direction 129.

In particular, an extension of a flat member 125 in its vertical direction 158, which runs substantially perpendicularly to the areal extension directions 154 and 156, is considerably smaller, in particular at least 10 times smaller, e.g., at least 100 times smaller, than the extension of the flat member 125 in its areal extension directions 154, 156, wherein in particular the vertical direction 158 runs at least substantially in parallel with the stacking direction 129 when the flat members 125 are stacked in the stack 127.

The flat members 125 each have outer sides 165 and 167 that are opposite one another in their vertical direction 158 and the area of which extends in the areal extension directions 154 and 156.

For example, the outer sides 165, 167 comprise structuring of different heights in the vertical direction 158, as will be explained in more detail below.

In particular, in the stack 127, flat members 125 stacked directly on top of one another rest at least partially on one another with their outer sides 165, 167 facing one another.

In particular, in some flat members, which are advantageously designed as a bipolar plate 143, one of their outer sides 165, 167 is assigned to one of two adjacent cell units 124 in each case.

For example, some flat members 125, in particular designed as membrane members 144, are arranged in a cell unit 124.

At least some, preferably at least most, of the several flat members 125 each have a functional region 172 in which in particular functional structure parts are arranged, wherein the one or more functional structure parts in each functional region 172 serve to fulfill at least one function of each flat member 125.

For example, the flat members designed as membrane members 144 have at least one membrane in their functional region 172, in particular for dividing at least one reaction chamber.

Advantageously, the flat members 125 designed as bipolar plates 143 have, in particular, vertically profiled fluid-carrying structures as functional structure parts, which are designed, for example, as channel structures, at least in part. In particular, at least some fluid-carrying structures at least partially form the reaction chamber. In particular, at least some fluid-carrying structures at least partially form line portions for a fluid.

In particular, at least some of the fluid-carrying structures are part of the line apparatus 114 for the fuel medium and/or the line apparatus 116 for the oxidation medium. In particular, some of the line portions are designed to supply the anode fluid mixture or the cathode fluid mixture to at least one reaction chamber, and some line portions are designed to discharge the residual anode fluid mixture or the residual cathode fluid mixture from at least one reaction chamber.

For example, at least some of the fluid-carrying structures are part of the line apparatus 134 and carry the temperature-control medium in particular so as to provide heat-exchanging contact in the region of the functional region 172.

Advantageously, the fluid-carrying structures traverse at least a large part of the functional region 172 of a flat member 125, and, for example, at least parts of the fluid-carrying structures 174 have branched structures.

In particular, the fluid-carrying structures have a complex design and are shown in the drawings, e.g., in FIG. 3, only in a simplified schematic manner.

In particular, some flat members, in particular those designed as bipolar plates 143, have electrical functional structure parts in their functional region 172, in particular for forming the electrode, i.e., in particular depending upon the side of the bipolar plate intended to form the anode or cathode, and/or for electrical connection to an electrode of an adjacent cell unit 124.

The flat members 125, 143, 144 have an edge 183 up to which the flat member 125, 143, 144 extends in its areal extension plane, and wherein the edge extends so as to be circumferentially closed.

In addition, the flat members 125, 143, 144 have an edge region 185 which extends inward from the edge 183, and wherein the edge region 185 advantageously surrounds the functional region 172 so as to be circumferentially closed.

In particular, as shown by way of example in FIGS. 2 and 3, several recesses 189 are formed in the edge region 185 for other components to pass through.

For example, at least four, advantageously six, recesses 189I to 189VI are formed in which, as parts of the line apparatuses 114, 116 for the fuel medium and the oxidation medium and, for example, the line apparatus 134 of the temperature-control apparatus, a particular distributor structure for supplying and discharging the particular medium is arranged, wherein the distributor structure is often also referred to as a manifold.

In particular, a particular recess 189 is delimited by a delimiting portion 192, and the delimiting portion 192 surrounds the recess 189.

In particular, a boundary portion 192 includes a boundary edge portion 194 in at least some recesses 189. The boundary edge portion 194 forms a portion of the edge 183. In particular, the boundary edge portion 194 runs at least along a part of the recess 189 and extends transversely to this course between the recess 189 and the edge 183.

In particular, the boundary portion 192 has a boundary separation portion 196 in at least some recesses 189. In particular, the boundary separating portion 196 is formed between two recesses 189 and is in particular a portion of two boundary portions 192, which each delimit two different recesses 189. In particular, the boundary separating portion 196 runs along at least a part of the at least one recess 189 which it defines and extends transversely to this course between the two recesses 189 which it defines.

In particular, the boundary portion 192 comprises an inner boundary portion 198 in at least some recesses 189. In particular, the inner boundary portion 198 is formed in the edge region 194. In particular, “inner” refers to the fact that the edge region 185 surrounds a region in a circumferentially closed manner, and the inner boundary portion 198 is located closer to the circumferentially surrounded region than the recess 189. In particular, the inner boundary portion 198 runs along at least a part of the recess 189 and extends transversely to this course between the recess 189 and the inner region surrounded by the edge region 185. For example, the inner boundary portion 198 extends between the recess 189 and the functional region 172.

In particular, at least two adjacent flat members 125 are rigidly connected to one another in their edge regions 185, in particular welded.

In particular, at least some flat members 125, advantageously at least most of the flat members 125 designed as bipolar plates 143 and, for example, at least some flat members 125 designed as membrane members 144, comprise at least two, in particular metallic, flat products 252. For example, at least some flat members 125 are formed at least substantially from flat products 252.

By way of example, FIGS. 3 and 4 show a variant with two flat products 2521 and 252II, wherein, in other variants, at least one further flat product 252 also forms a corresponding flat member 125.

In particular, the flat products 252 of a flat member 125 form layers thereof.

The flat products 252 of a flat member 125 are arranged one on top of the other in the vertical direction 158 which is substantially perpendicular to the geometric areal extension plane of the flat member 125.

Should the flat products 252 of a flat member 125 be at least substantially identical in terms of their basic function and/or design, they will be collectively described below with reference to “the flat product 252.”

For example, the flat product 252 is a metal sheet.

In particular, the flat product 252 has an edge 253 to which the flat product 252 extends, and wherein the edge 253 is circumferentially closed.

In addition, the flat product 252 has an edge region 255, wherein the edge region 255 extends inward from the edge 253, and wherein the edge region 255 advantageously surrounds an inner region, e.g., a functional region, of the flat product 252 in a circumferentially closed manner.

In particular, the edge 183 of the flat member 125, 143, 144 is formed by the edges 253 of those flat products 252, wherein those flat products 252 form the flat member 125, 143, 144.

In particular, the edge region 185 of a flat member 125, 143, 144 is formed by the edge regions 255 of those flat products 252, wherein those flat products 252 form the flat member 125, 143, 144.

The flat product 252 has two opposite flat sides 264 and 266, which are spaced apart from one another by a thickness 268, as shown by way of example in FIG. 4.

In the case of flat members 125 comprising several flat products 252, respective outer flat sides 264, 266 of two outer flat products 252 form the outer sides 165, 167 of the flat member 125, and inner flat sides 264, 266 face a flat side 264, 266 of a further flat product 252. For example, the outer flat side 2641 of the flat product 2521 forms the outer side 165 and the flat side 266II of the flat product 252II forms the outer side 167, and the inner flat sides 2661 and 264II of the flat products 2521 and 252II are arranged opposite one another, as shown by way of example in FIG. 4.

In particular, in the case of a flat member designed as a bipolar plate 143, a flat product 252, which forms one of the outer sides 165, 167 of the flat member, forms an electrode for an associated cell unit 124 in each case and is therefore an electrode position of the flat member 125.

In particular, the flat product 252 has a thickness 268 which is considerably smaller, in particular at least 10 times smaller, e.g., at least 100 times smaller, than extensions of the flat product 252 in directions of extension 286 and 288 which run at least substantially perpendicularly to one another and which at least locally run at least substantially perpendicularly to the thickness direction. In the thickness direction, the thickness 268 is measured.

For example, a thickness 268 of the flat product 252 is at least approximately between 0.05 mm and 0.3 mm.

In particular, structures are formed in the flat products 252, which cause local differences in the height of the flat product 252 and, for example, of the flat member 125.

In particular, the height is measured in a height direction 272.

Advantageously, in the functional region 172 of flat members, which are designed in particular as bipolar plates 143, at least some of the structures formed into a flat product 252 form at least some fluid-carrying structures of the flat member.

Because structures that rise from the areal extension plane, e.g., the fluid-carrying structures, are preferably formed in the flat product 252, the directions of extension 286 and 288 of the flat product 252 do not necessarily locally extend at least substantially in parallel with the areal extension plane, but, for example, the directions of extension 286 and 288 averaged over the extension of the flat member 125 in the areal extension directions 154 and 156 extend at least approximately in parallel with the areal extension plane.

In particular, the height direction 272 runs at least substantially perpendicular to the surface extension plane and/or to the geometric plane spanned by the averaged extension directions 286, 288.

An extension of the flat member 125 in the vertical direction 158 is greater than the sum of the thicknesses 268 of the flat product 252 forming the flat member 125 due to the structures emerging from the areal extension plane, such as the fluid-carrying structures, as shown by way of example in FIG. 4.

In particular, at least some flat products 252 each have at least one recess 289.

In this case, recesses 289 of different flat products 252, wherein these different flat products 252 form a flat member 125, together form a recess 189 of the flat member 125. Advantageously, those recesses 289 in different flat products 252, wherein those recesses 289 together form a recess 189 of a flat member 125, are formed at least substantially flush with one another.

In particular, at least some flat products 252 each have a boundary portion 292 at their recesses 289, which surrounds and limits the particular recess 289.

Conveniently, at least some boundary portions 192 in at least some flat products 252 each comprise at least one boundary edge portion 294 and/or one boundary separating portion 296 and/or one inner boundary portion 298.

In particular, a formation and/or position of a boundary portion 292 and/or a boundary edge portion 294 and/or a boundary separating portion 296 and/or an inner boundary portion 298 in a flat product 252 is designed in a corresponding manner to a boundary portion 192 or a boundary edge portion 194 or a boundary separating portion 196 or an inner boundary portion 198 of a flat member 125, so that, in this regard, reference can and will be made in full to the above explanations in order to avoid repetition.

In particular, a boundary portion 192 of a flat member 125 is formed from corresponding boundary portions 292 of the flat products 252 which form the flat member 125.

In particular, a boundary edge portion 194 of a flat member 125 is formed from corresponding boundary edge portions 294 of the flat products 252 which form the flat member 125.

In particular, a boundary separation portion 196 of a flat member 125 is formed from corresponding boundary separation portions 296 of the flat products 252 which form the flat member 125.

In particular, an inner boundary portion 198 of a flat member 125 is formed from corresponding inner boundary portions 298 of the flat products 252 which form the flat member 125. In particular, at least portions of a boundary portion 192, 292, in particular boundary edge portions 194, 294 and/or boundary separating portions 196, 296, are designed as web portions, because an extension of these portions along a course of these portions, e.g., a course along the recess 189, 28, is greater, in particular substantially greater, than an extension of this portion along the extension transverse to the course.

In particular, the several flat products 252 of the flat member 125 are welded together with at least one weld seam 312, as shown by way of example in FIG. 3.

In particular, at least one weld seam 312 is a sealing weld seam 312, wherein at least an at least partial course of the sealing weld seam surrounds a region to be sealed in a circumferentially closed manner.

In particular, at least two flat products 252 of the flat member 125 are connected to one another in a fluid-tight manner by the sealing weld seam 312.

Advantageous embodiments of a sealing weld seam 312 explained below relate to a sealing weld seam 312 between flat components 125, 252, i.e., in particular, a sealing weld seam 312 between flat products 252 of a flat member 125 and/or a sealing weld seam 312 between flat members 125.

For example, different partial courses of a sealing weld seam 312 surround in a circumferentially closed manner different regions to be sealed.

In some variants, several sealing weld seams 312 are provided, each of which runs in a circumferentially closed manner with at least one at least partial course around at least one region to be sealed.

In particular, the functional region 172 of at least one flat component, e.g., at least one flat member 125 and/or at least one flat product 252, is circumferentially closed at least by an at least partial course of a sealing weld seam 312.

In particular, at least some of the recesses 189, 289, in particular at least some of the recesses 189, 289 for a particular distribution structure of the line apparatuses 114, 116, 134, are circumferentially closed at least by an at least partial course of a sealing weld seam 312.

Advantageously, at least one at least partial course of a sealing weld seam 312 separates at least some recesses 189, 289 from the edge 183 in a fluid-tight manner.

Advantageously, at least some of the recesses 189, 289 are separated from one another in a fluid-tight manner by at least a partial course of at least one sealing weld seam 312.

In particular, at least one sealing weld seam 312 runs at least partially in the edge region 185, 255.

The advantageous formation of a weld seam 312, in particular a sealing weld seam 312, explained below refers to at least one weld seam 312 between several flat components—for example, between several flat members 125 and/or between several flat products 252.

The weld seam 312 runs along a weld contour 316 in a direction 318.

Transverse to the weld contour 316, the weld seam 312 has a seam width 322, as shown by way of example in FIGS. 5 to 7. The seam width 322, measured in particular at least approximately perpendicular to the weld contour 316, is, for example, on the order of magnitude of one or a few tenths of a millimeter. Depending upon the variant, the seam width 322 is at least substantially constant at least in portions along the weld contour 316, and/or the seam width 322 varies at least in portions along the weld contour 316.

In some advantageous variants, the weld contour 316 has several branches.

In advantageous variants, the weld contour 316 has at least one partial contour which is a self-contained partial contour, so that the weld seam 312 has at least one self-contained, at least partial, course. In particular, in the case of a sealing weld seam 312, this is advantageous for sealing at least one region to be sealed.

In some advantageous variants, the entire weld contour 316 is a closed contour.

In some advantageous variants, different branches of the weld contour 316 form different partial contours. At least some of the partial contours are each closed within themselves, so that, advantageously, several different regions are circumferentially closed by the weld seam 312, which is in particular a sealing weld seam 312. This is shown as an example in FIG. 3 for a weld seam 312, which circumferentially closes some recesses 189, 289 with an at least partial course and circumferentially closes the functional region 172 with an at least partial course.

For example, at least an at least partial course of the weld contour 316 and thus an at least partial course of a weld seam 312, in particular a sealing weld seam 312, runs through a boundary portion 192, 292, circumferentially closed around a recess 189, 289 and, for example, at least in portions through a boundary edge portion 194, 294 and/or through a boundary separating portion 196, 296 and/or through an inner boundary portion 198, 298.

In particular, a weld seam is formed from at least one seam portion, i.e., from exactly one seam portion or from several seam portions.

In particular, a seam portion runs along the weld contour 316 from a seam start 326 of the seam portion to a seam end 328 of the seam portion.

In particular, a weld portion is welded from its weld start 326 to its seam end.

In particular, a seam portion extends in the direction of travel 318, e.g., at its seam start 326 and/or at its seam end 328, up to a terminating edge 332. In particular, the terminating edge 332 runs transversely to the direction of travel 318.

In particular, a weld seam 312, in particular at least one seam portion thereof, has two longitudinal sides 334, 336.

The two longitudinal sides 334, 336 of a weld seam 312 run at least substantially parallel to the weld contour 316 of this weld seam 312, and the weld seam 312 is formed between its two longitudinal sides 334 and 336.

In particular, a particular longitudinal side 334, 336 of a seam portion runs along the weld contour 316 from its seam start 326 to its seam end 328 and advantageously between the end edges 332 formed at the seam start 326 and the seam end 328.

In particular, the seam width 322 of a weld seam 312 corresponds to the distance between the two longitudinal sides 334, 336 of this weld seam 312.

Advantageously, in at least one region of overlap 352, at least a first portion 356I and a second portion 356II of a weld seam 312, in particular of a sealing weld seam 312, are formed so as to at least partially overlap along its weld contour 316 and in particular thus in its direction of extension 318.

In particular, the direction of travel 318 along the first portion 356I and the direction of travel 318 along the second portion 356II run at least approximately parallel to one another in the region of overlap 352, as shown by way of example in variants in FIGS. 5 and 6, or the running directions 318 in the first portion 356I and in the second portion 356II are oriented at most slightly obliquely to one another, as shown by way of example in a variant in FIG. 7.

In particular, the first portion 356I is a seam start 326′ or a seam end 328′ of a seam portion, and/or the second portion 356II is a seam start 326″ or a seam end 328″ of a seam portion.

For example, in at least one region of overlap 352, the first and second portions 356 are portions of the same seam portion, wherein the first portion 356I is the seam start 326 and the second portion 356II is the seam end 328 of this seam portion, or the first portion 356I is the seam end 328 and the second portion 356II is the seam start 326 of this seam portion. In particular, this seam portion runs along at least an at least partial course of the weld contour 316 of the weld seam 312, circumferentially closed around a region to be sealed.

For example, in at least one region of overlap 352 of a weld seam 312 comprising several seam portions, the first portion 356I is a portion of a first seam portion of this weld seam 312, in particular a seam start 326′ or a seam end 328′ of the first seam portion, and the second portion 356II is a portion of a second seam portion of this weld seam 312, in particular a seam start 326″ or a seam end 328″ of the second seam portion. For example, this first seam portion and this second seam portion of the weld seam 312 are seam portions of a circumferentially closed course of this weld seam 312, i.e., for example, seam portions of an at least partial circumferentially closed course or seam portions of the entire circumferentially closed course of the weld seam 312.

In particular, in some advantageous variants of a weld seam 312 exactly one region of overlap 352 is provided, and in some advantageous variants of a weld seam 312 several region of overlaps 352 is provided. Preferably, the precisely one region of overlap 352 and/or the several region of overlaps 352 and the portions 356 formed therein at least partially overlapping are at least partially formed as follows.

In particular, the first portion 356I and the second portion 356II overlap in an overlap sector 362, so that, in the overlap sector 362 the first portion 356 and the second portion 356 are welded.

In particular, the overlap sector 362 is formed elongated along the weld contour 316.

In some advantageous variants, in the region of overlap 352, at least one longitudinal side 334, 336 of a partially overlapping portion 356 is formed, at least in portions, at least substantially on a longitudinal side 334, 336 of the other at least partially overlapping portion 356, as is shown by way of example in a variant in FIG. 5.

For example, in the region of overlap 352, at least in portions, both opposite longitudinal sides 334 and 336 of an at least partially overlapping portion 356 are each formed superimposed with a longitudinal side 334, 336 of the other at least partially overlapping portion 356.

In some advantageous variants, at least one longitudinal side 334, 336 of one of the at least partially overlapping portions 356 runs in the region of overlap 352, at least in portions between the two longitudinal sides 334 and 336 of the other overlapping portion 356, as shown by way of example for different variants in FIGS. 6 and 7.

It is particularly advantageous if, in the region of overlap 352, the terminating edge 332 of at least one at least partially overlapping portion 356 runs at least partially between the longitudinal sides 334 and 336 of the other at least partially overlapping portion 356, and, in particular, at least one portion of the terminating edge 332 is formed in the region of the weld seam of the other overlapping portion 356, as shown by way of example for different variants in FIGS. 5 to 7.

In particular, the overlap sector 362 is thus delimited at least in portions by longitudinal sides 334, 336 of the at least partially overlapping portions 356 and preferably in portions by at least one terminating edge 332 of at least one at least partially overlapping portion 356.

In particular, the overlap sector 362 has an overlap length 366 and an overlap width 368, wherein the overlap length 366 and the overlap width 368 are measured transversely to one another, as exemplified in FIGS. 5 to 7.

In particular, the overlap length 366 is measured along an elongated extent of the overlap sector 362. For example, the overlap length 366 is measured in the direction of the longest extent of the overlap sector 362.

Advantageously, the overlap length 366 is at least a few tenths of a millimeter, and, for example, a few millimeters.

In particular, the overlap length 366 is measured at least up to a terminating edge 332 of one of the at least partially overlapping portions 356. If the terminating edges 332 of the two at least partially overlapping portions 356 at least partially delimit the overlap sector 362, the overlap length 366 is advantageously measured between the end edge 332 of one of the at least partially overlapping portions 356 and a terminating edge 332 of the other at least partially overlapping portion 356.

In particular, the overlap length 366 is measured at least approximately in the direction 318 of the weld contour 316.

Advantageously, the overlap width 368 is on the order of magnitude of the seam width 322 of the weld seam 312. For example, the overlap width 368 is at least largely at least 10%, preferably at least 50%, of the seam width 322.

In particular, the overlap width 368 is measured at least in portions between longitudinal sides 334, 336 of the at least partially overlapping portions 356.

For example, the overlap width 368 is measured at least in portions between longitudinal sides 334, 336 of the same portion 356, as shown by way of example for variants in FIGS. 5 and 7, and/or the overlap width 368 is measured at least in portions between longitudinal sides 334, 336 of different portions 356, as shown by way of example for variants in FIGS. 5, 6, 7.

Advantageously, in some variants, the overlap width 368 is constant at least in portions, and/or the overlap width 368 varies at least in portions.

Ideally, the overlap width 368 is at least a few hundredths of a millimeter.

Preferably, at least one of the at least partially overlapping portions 356 comprises a ramp portion 382, as shown by way of example for various variants in FIGS. 8 to 11.

In some advantageous variants, only a portion 356 comprises a ramp portion 382, as shown by way of example in FIG. 8 for one variant.

In advantageous variants, two at least partially overlapping portions 356 each comprise a ramp portion 382, as shown by way of example for variants in FIGS. 9 to 11.

Different formations of a ramp portion 382, as shown by way of example in FIGS. 8 to 11, are provided both in variants with only one ramp portion 382 and in variants with two ramp portions 382, and further advantageous embodiments, e.g., with regard to an overlap of the ramp portions 382 and/or with regard to a variation of a penetration depth into the ramp portion, are provided in different combinations in different variants, so that the exemplary representations in FIGS. 8 to 11 are also representative of such combinations.

In a ramp portion 382, a penetration depth 386 of a weld formation is smaller than a typical penetration depth of the weld formation outside the ramp portion 382.

In particular, the weld formation of a portion 356 in its ramp portion 382 is thus reduced.

In particular, a ramp portion 382 of a portion 356 extends to the terminating edge 332 of this portion 356.

In some advantageous variants, at least one of the at least partially overlapping portions 356 is designed as a ramp portion 382 at least substantially at every point of the overlap sector 362, as shown by way of example for various variants in FIGS. 8 to 10.

In some advantageous variants, the at least partially overlapping portions 356 have their typical penetration depth at least in a region 388 of the overlap sector 362, as shown by way of example for a variant in FIG. 11.

In some advantageous variants, the penetration depth 386 decreases continuously, at least in portions, in the ramp portion 382, as shown by way of example for variants in FIGS. 8 to 10. For example, the penetration depth 386 decreases at least in portions linearly and/or at least in portions more or less than linearly.

In some advantageous variants, the penetration depth 386 decreases in at least one ramp portion 382 in a step-like manner, at least in portions, as is shown by way of example for a variant in FIG. 11.

For example, a step is provided in which the penetration depth 386 decreases at least substantially abruptly from the typical penetration depth to a reduced penetration depth in the ramp portion 382. For example, at at least one step within the ramp portion 382, the penetration depth 386 decreases substantially abruptly from a smaller value to an even smaller value. For example, the penetration depth 386 decreases abruptly from a smaller value to the value zero, particularly at the terminating edge 332, so that the ramp portion 382 and the portion 386 end at this step.

For example, by forming the ramp portion 382 in its region, a seam width 322 becomes larger, in particular when the welding device is defocused, as shown by way of example for a variant in FIG. 7.

In a method for producing a weld seam 312, a ramp portion 382 can be produced in a variety of ways.

For example, the formation of a ramp portion 382 is accomplished by a power regulation during welding and/or by a change in a relative movement between the welding device and the workpieces to be welded and/or by a defocusing of the welding device.

The weld seam 312 can be produced using a variety of welding methods.

In advantageous embodiments, the weld seam 312 is formed by laser welding.

In particular, advantageous designs of a weld seam 312 and examples of advantages thereof are briefly summarized as follows.

In a region of overlap 352, at least two portions 356 of the weld seam 312 are formed to overlap at least partially along the weld contour 316 of the weld seam 312. In particular, the at least partially overlapping portions 356 are a seam start 326 or a seam end 328, respectively, of the same seam portion or of different seam portions.

In particular, one advantage of this is that, due to the overlapping design of the portions 356 in the direction of the running direction 318, the weld seam 312 is also continuous in the region of overlap 352, and a space-saving solution is realized.

Preferably, at least one of the at least partially overlapping portions 356 has a ramp portion 382 with at least partially reduced penetration depth 386 of the weld formation.

For example, this achieves that, in the overlap sector 362, at least one of the at least partially overlapping portions 356 has a smaller weld formation, and, advantageously, a seam elevation of the weld seam 312 over a surface surrounding the weld seam 312 is thus at least reduced.

Advantageously, seam irregularities, which occur in particular at a seam start 326 and/or a seam end 328, can be at least reduced by the formation of the ramp portion 382.

In embodiments known in the prior art, for example, it is provided that portions 356 of a weld seam 312 intersect, as shown by way of example in FIG. 12.

In order not to impair the weld seam 312 and the region of the workpiece to be welded by the seam start and/or the seam end of at least one of the intersecting portions 356, it is provided to form at least one intersecting portion sufficiently long starting from the intersecting point, and thus to form its seam start and/or its seam end away from the weld seam 312 and the region to be welded, for which additional space is required.

### LIST OF REFERENCE SIGNS

100 fuel-cell device
110 fuel-cell unit
112 line system
114 line apparatus for fuel medium
116 line apparatus for oxidation medium
124 cell units
125 flat member (flat component)
127 stack
129 stacking direction
132 temperature-control apparatus
134 line apparatus of the temperature-control apparatus
143 bipolar plate (flat component)
144 membrane member (flat component)
154 areal extension direction
156 areal extension direction
158 vertical direction
165 outer side
167 outer side
172 functional region
174 fluid guide structure
183 edge
185 edge region
189 recess
192 boundary portion
194 boundary edge portion
196 boundary separation portion
198 inner boundary portion
252 flat product
253 edge
255 edge region
264 flat side
266 flat side
268 thickness
272 vertical direction
286 direction of extension
288 direction of extension
289 recess
292 boundary portion
294 boundary edge portion
296 boundary separation portion
298 inner boundary portion
312 (sealing) weld seam
316 weld contour
318 direction of travel
322 seam width
326 seam start
328 seam end
332 terminating edge
334 longitudinal side
336 longitudinal side
352 region of overlap
356 portion
362 overlap sector
366 overlap length
368 overlap width
382 ramp portion
386 penetration depth
388 region of overlapping portions with typical penetration depth

1. An arrangement comprising several flat components (125, 143, 144, 252), in particular for a fuel-cell device (100), wherein at least two flat components (125, 143, 144, 252) are welded together by at least one weld seam (312) which runs along a weld contour (316), and wherein, in at least one weld seam (312), at least two portions (356) of the weld seam (312) are formed to at least partially overlap in a region of overlap (352) along the weld contour (316).

2. The arrangement according to claim 1, characterized by at least one of the following:
that at least some of the welded flat components (125, 143, 144, 252), are each a flat product (252);
and/or
that the arrangement comprises a bipolar plate (143), which is at least partially formed from at least some of the welded flat components (125, 143, 144, 252).

3. The arrangement according to claim 1, characterized by at least one of the following:
that at least some of the welded flat components (125, 143, 144, 252), are each a flat member (125, 143, 144);
and/or
that at least some of the welded flat components (125, 143, 144, 252), at least co-form a stack (127) of flat components (125, 143, 144, 252) arranged one above the other.

4. The arrangement according to claim 1, characterized in that at least one region of overlap (352) of at least one of the at least two at least partially overlapping portions (356) is a seam start (326) or a seam end (328) of at least one seam portion of the weld seam (312),
that the at least two at least partially overlapping portions (356) are the seam start (326) and/or the seam end (328), respectively.

5. The arrangement according to claim 1, characterized in that, in at least one region of overlap (352), a terminating edge (332) of at least one portion (356) of the at least two at least partially overlapping portions (356) is at least partially formed in another portion (356) of the at least two at least partially overlapping portions (356) of the weld seam (312).

6. The arrangement according to claim 1, characterized in that, in at least one region of overlap (352), an overlap width (368), which is measured transversely to the weld contour (316), is at least 10%, of a seam width (322) of at least one of the at least two overlapping portions (356).

7. The arrangement according to claim 1, characterized in that, in at least one region of overlap (352), at least one longitudinal side (334, 336) of a portion (356) of the at least two at least partially overlapping portions (356) and at least one longitudinal side (334, 336) of another portion (356) of the at least two at least partially overlapping portions (356) run at most slightly obliquely to one another and/or at most slightly obliquely to the course of the weld contour (316) in the region of overlap (352).

8. The arrangement according to claim 1, characterized in that, in at least one region of overlap (352), an overlap sector (362) of the at least two at least partially overlapping portions (352) is delimited at least in portions along the weld contour (316) transversely to the weld contour (316) on one side by a longitudinal side (334, 336) of a portion (356) of the at least two portions (356) and on the other side by a longitudinal side (334, 336) of another portion (356) of the at least two portions.

9. The arrangement according to claim 8, characterized in that, in at least one region of overlap (352), the overlap sector (362) of the at least two at least partially overlapping portions (356) is elongated, and in particular a direction of the elongated extent of the overlap sector (362) runs at most slightly obliquely, in particular at least approximately parallel, to the course of the weld contour (316) in the region of overlap (352).

10. The arrangement according to claim 1, characterized in that, in at least one region of overlap (352), at least one portion (356) of the at least two at least partially overlapping portions (356) of the weld seam (312) has a ramp portion (382), wherein, in the ramp portion (382), a penetration depth (386) of the weld seam (312) of the at least one portion (356) is smaller than the penetration depth (386) in the at least one portion (356) outside the ramp portion (382).

11. The arrangement according to claim 10, characterized by at least one of the following:
that, in at least one ramp portion (382), the penetration depth (386) changes in a step-like manner at least in portions;
and/or
that, in at least one ramp portion (382), the penetration depth (386) changes continuously at least in portions with an increasing extension of the ramp portion (382);
and/or
that, in at least one ramp portion (382), the penetration depth (386) changes at least in portions at least substantially linearly with an increasing extension of the ramp portion (382);
and/or
that, in at least one ramp portion (382), the penetration depth (386) changes at least in portions increasingly and/or decreasingly with an increasing extension of the ramp portion (382).

12. The arrangement according to claim 10, characterized in that, in at least one region of overlap (352), at least two portions (356) of the weld seam (312) are formed to at least partially overlap with their respective ramp portions (382),
wherein in particular at least one of the following is provided:
that, in at least one region of overlap (352), the at least two portions (356) be formed to overlap only with their respective ramp portions (382);
and/or
that, in at least one region of overlap (352), at least one of the at least two portions (356) be formed to at least partially overlap with its ramp portion (382) at least one other portion (356) outside the ramp portion (382) of the other portion (356);
and/or
that, in at least one region of overlap (352), the at least two portions (356) of the weld seam (312) be formed to partially overlap outside their ramp portions (382).

13. The arrangement according to claim 8, characterized in that, in at least one region of overlap (352), in the overlap sector (362) of the at least two at least partially overlapping portions (356), a seam elevation of the weld seam (312) above a geometric reference plane defined by the surroundings of the weld seam (312) is at most 0.08 mm, in particular at most 0.05 mm, in particular at most 0.03 mm, in particular at most 0.01 mm.

14. The arrangement according to claim 1, characterized in that at least one weld seam (312) with at least two at least partially overlapping portions (356) has at least one circumferentially self-contained, at least partial, course, and in particular the weld seam (312) is a sealing weld seam, and the circumferentially self-contained, at least partial, course surrounds a region to be sealed in a closed manner on the circumferential side.

15. The arrangement according to claim 1, characterized by at least one of the following:
that at least one of the welded flat components (125, 143, 144, 252) is at least partially formed from a metallic material;
and/or
that at least one flat component (125, 143, 144, 252), in particular at least one of the welded flat components (125, 143, 144, 152), is part of an electrical device, in particular is an electrode layer;
and/or
that at least one flat component (125, 143, 144, 252), in particular at least one of the welded flat components (125, 143, 144, 252), at least co-forms at least line portions of a line system (112) for at least one fluid medium.

16. A fuel-cell device (100) comprising several flat components (125, 143, 144, 252), wherein at least two flat components (125, 143, 144, 252) are welded together by at least one weld seam (312) which runs along a weld contour (316), and wherein, in at least one weld seam (312), at least two portions (356) of the weld seam (312) are formed so as to at least partially overlap in a region of overlap (352) along the weld contour (316).

17. The fuel-cell device (100) according to claim 16, characterized by at least one of the following:
that at least some of the welded flat components (125, 143, 144, 252), are each a flat product (252);
and/or
that the fuel-cell device (100) comprises a bipolar plate (143), which is at least partially formed from at least some of the welded flat components (125, 143, 144, 252).

18. The fuel-cell device (100) according to claim 16, characterized by at least one of the following:
that at least some of the welded flat components (125, 143, 144, 252), are each a flat member (125, 143, 144);
and/or
that at least some of the welded flat components (125, 143, 144, 252), at least co-form a stack (127) of flat components (125, 143, 144, 252) arranged one above the other.

19. The fuel-cell device (100) according to claim 16, characterized in that at least one region of overlap (352) of at least one of the at least two at least partially overlapping portions (356) is a seam start (326) or a seam end (328) of at least one seam portion of the weld seam (312),
that the at least two at least partially overlapping portions (356) are the seam start (326) and/or the seam end (328), respectively.

20. The fuel-cell device (100) according to claim 16, characterized in that, in at least one region of overlap (352), a terminating edge (332) of at least one portion (356) of the at least two at least partially overlapping portions (356) is at least partially formed in another portion (356) of the at least two at least partially overlapping portions (356) of the weld seam (312).

21. The fuel-cell device (100) according to claim 16, characterized in that, in at least one region of overlap (352), an overlap width (368), which is measured transversely to the weld contour (316), is at least 10% of a seam width (322) of at least one of the at least two overlapping portions (356).

22. The fuel-cell device (100) according to claim 16, characterized in that, in at least one region of overlap (352), at least one longitudinal side (334, 336) of a portion (356) of the at least two at least partially overlapping portions (356) and at least one longitudinal side (334, 336) of another portion (356) of the at least two at least partially overlapping portions (356) run at most slightly obliquely to one another and/or at most slightly obliquely to the course of the weld contour (316) in the region of overlap (352).

23. The fuel-cell device (100) according to claim 16, characterized in that, in at least one region of overlap (352), an overlap sector (362) of the at least two at least partially overlapping portions (352) is delimited at least in portions along the weld contour (316) transversely to the weld contour (316) on one side by a longitudinal side (334, 336) of a portion (356) of the at least two portions (356) and on the other side by a longitudinal side (334, 336) of another portion (356) of the at least two portions.

24. The fuel-cell device (100) according to claim 23, characterized in that, in at least one region of overlap (352), the overlap sector (362) of the at least two at least partially overlapping portions (356) is elongated, and in particular a direction of the elongated extent of the overlap sector (362) runs at most slightly obliquely, in particular at least approximately parallel, to the course of the weld contour (316) in the region of overlap (352).

25. The fuel-cell device (100) according to claim 16, characterized in that, in at least one region of overlap (352), at least one portion (356) of the at least two at least partially overlapping portions (356) of the weld seam (312) has a ramp portion (382), wherein, in the ramp portion (382), a penetration depth (386) of the weld seam (312) of the at least one portion (356) is smaller than the penetration depth (386) in the at least one portion (356) outside the ramp portion (382).

26. The fuel-cell device (100) according to claim 25, characterized by at least one of the following:
that, in at least one ramp portion (382), the penetration depth (386) changes in a step-like manner at least in portions;
and/or
that, in at least one ramp portion (382), the penetration depth (386) changes continuously at least in portions with an increasing extension of the ramp portion (382);
and/or
that, in at least one ramp portion (382), the penetration depth (386) changes at least in portions at least substantially linearly with an increasing extension of the ramp portion (382);
and/or
that, in at least one ramp portion (382), the penetration depth (386) changes at least in portions increasingly and/or decreasingly with an increasing extension of the ramp portion (382).

27. The fuel-cell device (100) according to claim 25, characterized in that, in at least one region of overlap (352), at least two portions (356) of the weld seam (312) are formed to at least partially overlap with their respective ramp portions (382),
wherein at least one of the following is provided:
that, in at least one region of overlap (352), the at least two portions (356) be formed to overlap only with their respective ramp portions (382);
and/or
that, in at least one region of overlap (352), at least one of the at least two portions (356) be formed to at least partially overlap with its ramp portion (382) at least one other portion (356) outside the ramp portion (382) of the other portion (356);
and/or
that, in at least one region of overlap (352), the at least two portions (356) of the weld seam (312) be formed to partially overlap outside their ramp portions (382).

28. The fuel-cell device (100) according to claim 23, characterized in that, in at least one region of overlap (352), in the overlap sector (362) of the at least two at least partially overlapping portions (356), a seam elevation of the weld seam (312) above a geometric reference plane defined by the surroundings of the weld seam (312) is at most 0.08 mm, in particular at most 0.05 mm, in particular at most 0.03 mm, in particular at most 0.01 mm.

29. The fuel-cell device (100) according to claim 16, characterized in that at least one weld seam (312) with at least two at least partially overlapping portions (356) has at least one circumferentially self-contained, at least partial, course, and in particular the weld seam (312) is a sealing weld seam, and the circumferentially self-contained, at least partial, course surrounds a region to be sealed in a closed manner on the circumferential side.

30. The fuel-cell device (100) according to claim 16, characterized by at least one of the following:
that at least one of the welded flat components (125, 143, 144, 252) is at least partially formed from a metallic material;
and/or
that at least one flat component (125, 143, 144, 252), in particular at least one of the welded flat components (125, 143, 144, 152), is part of an electrical device, in particular is an electrode layer;
and/or
that at least one flat component (125, 143, 144, 252), in particular at least one of the welded flat components (125, 143, 144, 252), at least co-forms at least line portions of a line system (112) for at least one fluid medium.

31. A method for producing an arrangement comprising several flat components (125, 143, 144, 252), for a fuel-cell device (100), wherein the method comprises at least the following steps:
providing several flat components (125, 143, 144, 252);
welding together at least two flat components (125, 143, 144, 252) of the several flat components (125, 143, 144, 252) with a weld seam (312) running along a weld contour (316);
welding at least two portions (356) of the weld seam (312), wherein, in at least one region of overlap (352), the at least two portions (356) of the weld seam (312) are welded so as to at least partially overlap along the weld contour (316).

32. The method according to claim 31, characterized in that at least one seam start (326) and/or one seam end (328) of a seam portion of the weld seam (312) is welded so as to at least partially overlap with the at least one seam start (326) and/or the one seam end (328) of a seam portion of the weld seam (312) in the at least one region of overlap (352).

33. The method according to claim 31, characterized in that, at least in the at least one region of overlap (352), at least one portion (356) of the at least two at least partially overlapping portions (356) of the weld seam (312) is welded to a ramp portion (382), wherein, in the ramp portion (382), a penetration depth (386) of the weld formation is smaller than a penetration depth (386) in the portion (356) outside the ramp portion (382),
wherein at least one of the following is provided:
that the ramp portion (382) is formed at least partially by a power regulation during welding;
and/or
that the ramp portion (382) is formed at least partially by changing a relative movement between the flat components (125, 143, 144, 252) to be welded together, and a welding device;
and/or
that the ramp portion (382) is formed at least partially by defocusing a welding laser beam;
and/or
that the ramp portion (382) is formed at least partially by widening a diameter of the welding laser beam.
